(19) United States
(12) Patent Application Publication
(10) Pub. No.: US 2001/0032154 A1
(43) Pub. Date: Oct. 18, 2001

(54) Internet communications and e-commerce platform

(76) Inventor: Eric Schummer, Miami, FL (US)

Correspondence Address: JOSEPH J. ZITO, 1300 I STREET, N.W., 11TH FLOOR EAST, WASHINGTON, DC, 20005-3314, US

(21) Appl. No.: 09/738,653

(22) Filed: Dec. 18, 2000

Related U.S. Application Data
(60) Provisional application No. 60/172,192, filed on Dec. 17, 1999.

(51) Int. Cl. G06F 17/60

(52) U.S. Cl. 705/30

(57) ABSTRACT

An Internet, communications and e-commerce platform provides a Web-based business creation environment with a managed infrastructure and business portals. The system supplies the means to build Internet-based business-to-business or business-to-consumer commerce combined with quality of service enabling self-management and information reporting via a single point of access for a variety of independent businesses in a hierarchical system. The system is designed to be an off-the-shelf solution for businesses that provides a commercial chain with which to reach the end users by leveraging the administration of commerce and communications over a network. The system provides the interfaces for distributors and agents of products and services, and also provides the interfaces for the actual end user objects, such as individual users, corporate users, telephone calling card managers.

### CROSS-REFERENCE TO RELATED APPLICATIONS

This application claims the benefit of U.S. Provisional Patent Application No. 60/172,192, Internet Communications and E-Commerce Platform, to Schummer filed Dec. 17, 1999.

### BACKGROUND

The Internet has provided the networking capability for global client/server software in commercial applications. Network-hosted applications reside on one or more servers that are accessed by one or more users. The users may be in the same location as the application server, or they may be remotely located in other offices, buildings, states, or countries. An application service provider (ASP) is a company that offers access to application software through a computer network. It is now possible for ASPs to use the Internet to take application software off of the personal computer platform and onto a thin client platform accessing an application server.

In a network environment, scalability becomes important. For network-hosted applications, the applications must be designed to scale up in orders of magnitude that also interact well within a communications infrastructure. The application must also be extensible to integrate with legacy computer systems that vary widely in operational and hardware aspects. The application must also be designed to scale for future upgraded systems that have not yet been developed. Standards-based architectures and languages are important, therefore, in the design of network-hosted applications. The classic programming language of hyper-text markup language (HTML) alone typically falls short of these needs. Java and XML are the preferred languages for supporting or supplanting HTML in this class of Web-based applications.

Through centralization of servers containing networked applications, the client-server model of application provision becomes efficient. Advantages to this system are easily discerned. The model is cost-efficient by replacing individual installations of software onto multiple desktop computers with one central application. Upgrades and initial installations are avoided, thereby creating consistent working platforms for each user. Also, remote users located worldwide can access and use the same application, creating consistency within a corporation or organization. In a mainframe environment, the network administrator could design and build for maximum user loads because the number of users was controlled by the administrator. The costs of mainframes also limited how much processing power was attainable by organizations. The cost savings of network hosted applications provides small to medium sized companies access to entire sets of applications that could not otherwise afford the costs of custom software, upgrades to the software, networks, and operating systems, and in-house network administration and management. In a client-server environment, the ASP performs the upgrades application which frees the client users from keeping current with the latest upgrades and patches.

Currently, Application Service Providers (ASPs) supply a virtual provider presence on the Internet by allowing businesses to outsource some or all of their computing needs. ASPs can be used to build the enhancements to a business portal which further empowers an Internet-based business by supplying it with one-stop access to applications which the business can then use to collect and structure its information as well as provide the business with one-stop access to its information. A traditional business portal provides access to information only after the product/service is being delivered and information is being collected concerning its use. If the information is not being collected a traditional business portal cannot provide access to it. Available ASPs can fill-in this missing information specification and structuring functionality but they fall short by only focusing on customer usage.

A client-server model is not a standard PC network. A client-server application sends processor-intensive functions, such as database query or modeling analysis, from the client to the server. More powerful applications than those that could be loaded on a desktop PC are accessed by the user while the user maintains control over the functions from the remote PC. The server applications move computing resources to the centralized server locations. Users can access a Web-based application and information from any computing device configured with Internet access and a Web browser. The user can keep the desktop operating system and GUI of choice. and Better performance is possible through servers having processing and memory capacity generally greater than that of a desktop computer.

### SUMMARY

The Internet, communications, and E-commerce software of the present invention combines E-commerce technologies with business management tools designed to provide a superior operating platform base for online businesses, traditional brick-and-mortar businesses, and ISPs (Internet service providers) to trade, track payments and sales, invoice, build business structures, and communicate through an IP packet-switched network. The platform provides centralized, real-time management of IP services and traditional business accounts across international borders, bypassing long-distance communication expenses and currency exchange difficulties. Resellers, distributors, and agents can administer their existing businesses over the Internet, or sell telecommunications, products, and services provided by an system administrator through the operating platform. On-line subscribers may create their own distributors and agents to and manage those accounts in real-time. The Web-based environment allows a subscriber to brand its own Web pages, or let customers brand their own pages, and use available IP-based enhanced services that cut time to market with much less investment.

The system platform of the preferred embodiment has the advantages of complete business solutions in one point of access, quality of service (QoS) solutions within a privately managed IP network, a complete IP operating platform with software and hardware managed by a system administrator, and flexible invoicing and accounting. The system provides a centralized, on-line business solution with a platform for businesses to leverage information access for invoicing, commissioning, subscribing, administration, communications, and E-commerce to customers. The platform allows a subscriber to track, monitor, and control virtually every detail of a business, including management of accounts, usage, payments, and reporting. Inexpensive international voice communication is provided to multinational businesses and telephony-based businesses through the managed state-of-the-art IP infrastructure.

The system is operated in an Internet-based environment where each business user can brand its own company as the provider or let subsequent customers brand their own businesses. Using standardized, integrated technology, IP providers of enhanced services can cut their time to market and create a more efficient on-line operational base with lower capital investment, lower communications costs, and integrated technologies to operate a business efficiently.

The hardware and software system provides the operations and infrastructure for any business that sells a product or service to quickly build commercial relationships in an organized structure to operate through the Internet. The system provides ways to maintain an account balances and purchase accounting for up to thousands of commercial transactions for purchasers and suppliers. A supplier can give different discounts to different purchasers which is saved and tracked within the system databases. An entire history of all transactions are then available as business reports anytime the subscriber logs into its personalized Web site for downloading. The sytem is a way to track real money from commercial transactions, whether paid in cash, check, credit card, letter of credit, or wire, within a centralized system. Commercial transactions across multiple international boundaries are streamlined by applying rules to a programmable application over the Internet.

The system platform is operated by a system administrator that provides quality of service hardware and software for voice, facsimile, and enhanced services over IP and allows for the resale and logistics management of these services nationally and internationally. Because the IP infrastructure is managed by the central system administrator, the features are available to subscriber for without having to administer individual networks and related hardware such as gateways, and manage high bandwidth and quality of service IP infrastructure that is critical to voice and facsimile communications over IP networks. The financial aspects of E-commerce under the system's platform provides for control of flow of money and credit electronically anywhere in the world and automated payments and accounting irrespective of site of origin.

The method provided is an open and programmable application. Specific business rules apply to all profiles subscribed but can change any time. Each transaction from every agent, reseller, or distributor is taggged with a particular form of payment. When performing international transactions, a distributor may sell an item in one currency to an agent or end user located in an area with a second, different currency. The transaction can be viewed by a parent account of one the parties in U.S. dollars based on a currency exchange tagged to the accounts at the time of transaction. The system monitors the chain of commercial transactions whether in immediate payments or credit between a a buyer and seller on a continual basis.

By partnering with the system administrator of the platform system, a subscriber gains real time, Web-based secure access to commerce and communications tools for business. The system works with any products or services for sale. In telelcommunications, if an internet service provider or telephone company want to sell services for payment, then the usage of those services can be monitored and translated into balances into the company's account.

### FIGURES

FIG. 1 is an illustration of the system network of the system.

FIG. 2 is a chart illustrating the modules and heirarchial relationships of the system.

FIG. 3 is a chart illustrating workflow process of the system.

FIG. 4 is a chart illustrating the the workflow operations of the system.

FIG. 5 is a chart illustrating the operations of a managing system administrator.

FIG. 6 is a chart illustrting the operations of a distributor.

FIG. 7 is a chart illustrating the operations of a reseller.

FIG. 8 is a chart illustrating the operations of an agent.

FIG. 9 is a chart illustrating the operations of a corporate agent.

FIG. 10 is a chart illustrating the accounting and billing operations of the system.

FIG. 11 is a chart illustrating the communications operations of the system.

### DETAILED DESCRIPTION OF THE PREFERRED EMBODIMENT

The exemplary preferred embodiment is an Internet, communications, and E-commerce system platform. The software platform is a web-based complete management and information delivery system that serves as the core network element manager and communications server for delivery of voice over internet protocol.

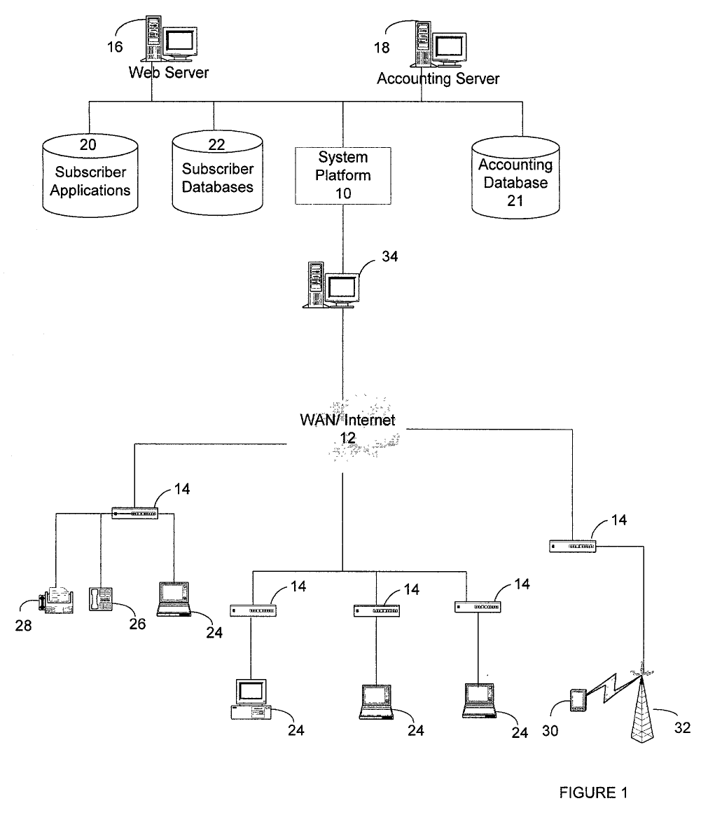

The networking aspects of the preferred embodiment are illustrated in FIG. 1. The system 10 of the present invention brings together combined technologies into a single point-of-access platform through the Internet 12. The system platform 10 of the present invention is operated over a managed Web-based network 12. The platform 10 is based on an international network of gateways 14 and centralized servers 16, 18, holding databases 22 and applications 20. The Web server 16 hosts the communications, E-commerce, and the system administrator applications. The accounting server 18 hosts commerce scripts used to access the accounting databases 21, subscriber applications 20, and subscriber databases 22 to fulfill and record commercial transactions. The Web server 16 also administers communication services such as voice over Internet Protocol (IP) 26 and fax over IP 28 through the system platform 10.

The system 10 provides a software service platform for on-line as well as brick-and-mortar businesses, Internet service providers (ISPs) and telephone carriers, using rules-based business models with tools to implement the models. Subscribers may utilize the system through personal computers 24, IP phones 26, facsimile machines 28, and wireless 32 personal digital assistants 30, or any other means for accessing the Internet 12. The users pass through a gatekeeper firewall 34 to prevent unauthorized access to the system. The platform 10 is customizable to interface seamlessly with a businesses on-line storefront or web presence with a standard method of accounting and billing. The system is based on a powerful server and thin-client model. A subscribing companies or individuals access the servers 16,18 through PCs 24 using standard Internet browsers. The servers 16,18 house the application software applications 20 and data 21,22 that are accessed by the clients 24.

The accounting server 18 is an infranet IPT server that runs an SQL database. The accounting server 18 integrates scripts to take information from the users 24 across the network and post them to the Portal database 21. Scripts then query the Portal Database 21 and pass information back to the appropriate reporting Web pages of the users 24. The accounting database 21 also contains the system administration and accounting objects, including records of all transactions, storage of receipts from commerce transactions, country to country code mappings, storage of login identifications and passwords, credit card transaction fee rates, and information regarding user 24 accounts.

Information may travel securely over the Internet 12 or through managed private Web-based networks to managed gatekeepers 14 located at major points of access, such as metropolitan areas or centralized geographic locations. Through the gatekeepers 14, individual gateways are distributed that allow users of the system to access a high-speed, secure network with the bandwidth and routing capabilities to provide quality of service for resource-intensive applications such as voice and video over IP at the user's desktop computers 24. The system may be modified to run on wireless PDAs 30 (personal digital assistants) for operability within wireless network connections 32 to the Internet 12.

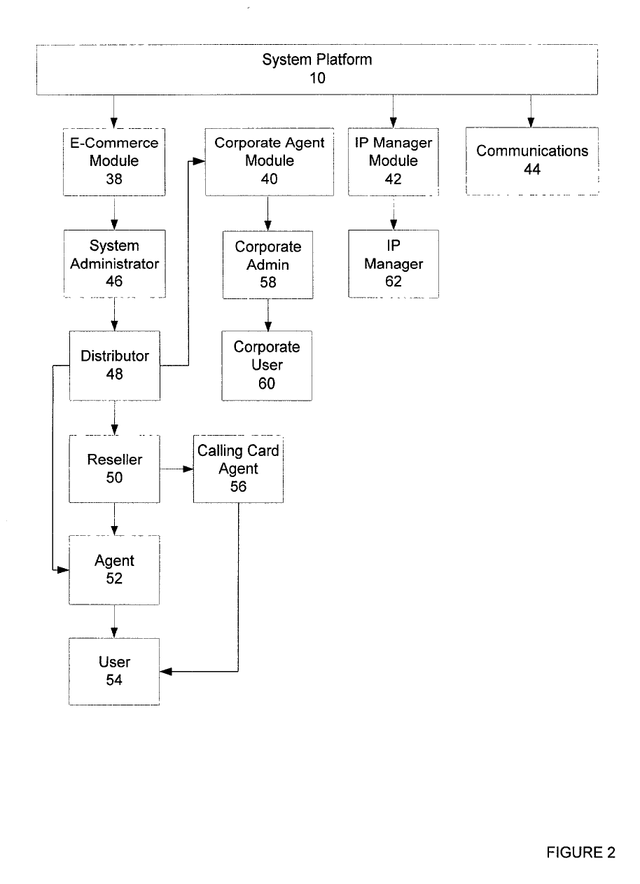

Referring to FIG. 2, the organizational hierarchy and the three primary modules of the system 10 are E-commerce 38, Corporate Agent 40, and IP Manager 42. Communications 44 are available to all modules through the platform 10. The E-commerce module 38 manages the commercial aspect of the relationship between the system administrator and its subordinate accounts 48-60. Access to the E-commerce 38 and Corporate Agent 40 modules are granted according to the status of the individual or company subscribed to the system 10. Subscribers to the system may be classified hierarchically as the system administrator 46, distributors 48, resellers 50, agents 52, and users 54. An IP manager 46 is the administrator of the application software and databases that comprise the platform 10. The IP manager 46 is also the administrator of the system platform 10 where commercial transactions originate and is responsible for security and integrity of the transactions, and management of the network infrastructure of FIG. 1. A distributor 48 is a subordinate account to the system administrator 46 and is a company that provides services to its own customer base through its own sales and marketing infrastructure. A reseller 50 is a commission-based sales account that can conduct business by delivering services to its individual customers by outsourcing administrative tasks. The reseller 50 operates under agreement with a distributor 48 and must be subscribed to the system platform 10 by a distributor 48.

Agents 52 are the subordinate accounts to distributors 48 or resellers 50 that interact with retail users 54. Agents 52 represent individuals or businesses, or they may represent other entities such as groups of telephone calling cards, a demonstration of customer groups, or a type of corporation being marketed. Agents 52 could also represent a salesperson, a corporate department, or a passing through account. The Corporate Agent Module 40 manages accounts specially adapted for corporate needs, rather than operations between two distinct private companies or individuals.

A user 54 is a retail customer purchasing products or services via public Internet access. A user 54 will access a reseller's or agent's Web page but the functions of the transaction are completed through the platform 10. Users 54 are not subscribers to the system but are granted certain account functions and actions within the system.

The IP Manager module 62 operates and controls the network inventory throughout the system, thereby creating a consistent and interoperable network for all subscribers and users. The the IP manager 62 handles the provisioning, management, and monitoring of devices connected to the system. Operations performed within the IP manager 62 include the changes in status of devices regarding other services, such as billing databases and gatekeepers.

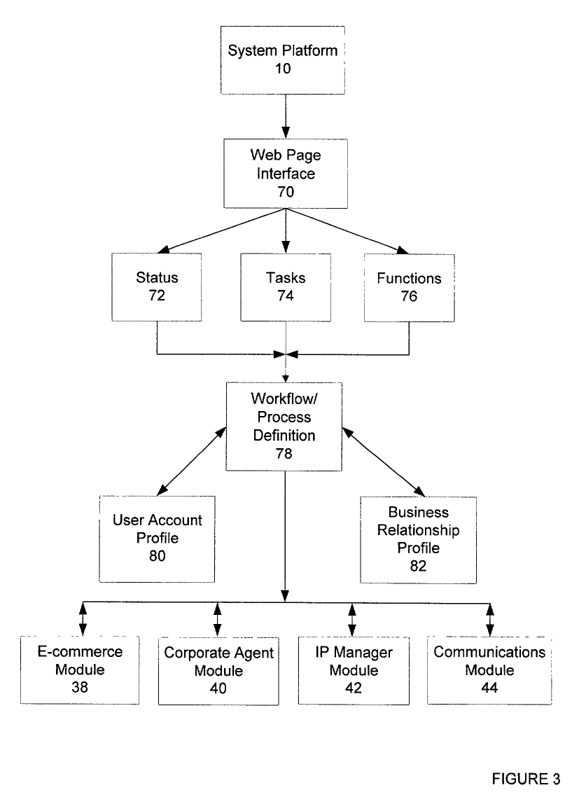

The E-commerce system provided by the platform presents a subscriber an online business system based on roles that exert operations on one another. The subscribers of E-commerce Module 38, interact through the Web pages 70 of the system with status 72, tasks 74, and functions 76 operations, as illustrated in FIG. 3. The role of a subscriber is part the workflow and process definition 78. For example, when a task 74 is presented, the system processes the task according to a subscriber's account profile 80 and business relationship profile 82 of the requesting and receiving subscribers. The originator of a process receives a status notification of its process and the result of the process, and notifications are sent to other subscribers according to the workflows definitions.

The appearance and format of E-commerce Web pages in the system are customizable by the parties using the pages. The system can manage “branded” versions of the Web pages for large customers who may have their own access to the system and portal graphical user interface (GUI) to the Web. The format and language of the subscriber or user interface to the platform can change, but the function of the pages remains consistent. However, the subscriber must be presented with activities the subscriber initiated, activities the subscriber was assigned, activities the subscriber monitors, and status. The presentation follows the processes the subscriber might interact in such as collection processes from other subscribers, applications processes for new applicants along with initial payments, reconciling and verifying the status of processes, collection from subordinate accounts to the subscriber, and verification of subordinate account process of collection of payments.

Grouped together, status 72, tasks 74, and functions 76, make up the workflow and processes 78 of the system platform 10. The status 72, task 74, and function 76 operations may be accessed from links on a Web page interface 70. The links vary according to the business relationship profile 82 and the access provisioned by a subscriber's parent account. Status and monitoring operations 72 contains the reporting necessary to assist subscribers in managing the current state of parent accounts, subordinate accounts, and the nature of relationships with both parent and subordinate relational accounts. Subscribers can actively perform tasks 74 and functions 76 in the system. Tasks 74 are generated by subscribers interactions within the system 10. Functions 76 are processes that are initiated by the subscriber. Through performing status checks 72, tasks 74, and functions 76, the subscriber interacts with the capabilities of the system platform 10.

The relationships between workflows 78 and subscribers are defined by account profiles 80 and business relationship profiles 82, which are databases establishing frameworks for connections between accounts. Through the workflows and process definitions, users perform transactions with the modules of the platforms.

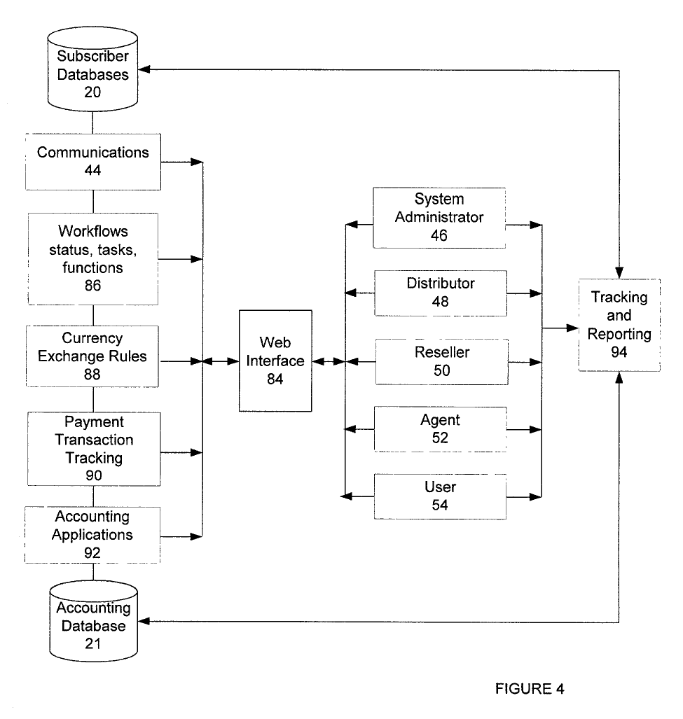

E-commerce transactions 86 involve a subscriber purchasing, paying, collecting, managing, receiving, consolidating, refunding, and tracking monetary transactions 90 are illustrated in FIG. 4. As the activities occur in real time, the system creates conversions 88 whereby subscribers gain profits on transactions. The E-commerce module of the system extracts the commercial parameters that summarize and contain a typical commercial transaction and provides the transactional information within system interfaces to the objects using the system. The module simultaneously serves many different user cases within a single chain of commerce, for example a user purchasing from an agent who purchases from a distributor who purchases from the system administrator.

In the system, each party, or object, in a commercial transaction belongs to a different class, each with varying behaviors, but all parties interact through workflows within the system. The workflows determine how objects from different classes interact between one another. Objects within a class can be vary to such an extent as to trigger a different workflow with an object in a subclass. An example of triggering a different workflow is a discount based agent, as opposed to a commission based agent. While the user and distributor could remain the same, the agent object in one case behaves to such a difference that the agent object in another case will produce a completely different set of transactions and calculations, including receivables, payables, and calculations of funds to be disbursed. The workflows are executed based on certain pre-defined conditions, and the branching of workflows is affected by the state of the objects and object characteristics. Therefore, rendering completely different results with different variations of the values of the objects in the middle of the transaction is possible within the system.

The workflows between account hierarchies 46-54, and accounting of transactions 92 in a preferred embodiment are maintained and organized within the platform 10. The preferred embodiment is a web-based, real-time, front-end business application system that comprises a collection of Web interfaces 84, custom designed business workflows 86, and Web-based communications capabilities 44. The interfaces 84 and workflows 86 are organized into a library of programmed functions and tasks and communications 44. The Web interface applications 84 read subscriber databases 20 to track each transaction 94 that is related to a particular subscriber or user. The subscriber databases 20, combined with accounting databases 21, record the business rules applied to each account. These business rules 86 include status, tasks, functions, payment notifications, new subscriptions, and schedule processes. The system administrator 46, distributor 48, reseller 50, agent 52, and user 54 are all subject to accounting 92 and subscriber 86 rules and applications. Accounting applications 92 provide payment tracking 90 and currency exchange rules 88 for all transactions between multiple subscribers 46-52 and/or users 54. All subscribers as well can track and create reports 94 of activities from subscriber 20 and accounting 21 databases according to privileges granted to the account at the time of subscription. Users 54 do not create reports, since they are retail purchasers, however, the transactions performed by users 54 are recorded and included in reports 94 for parent accounts 46-52. As illustrated in FIG. 1, the platform interface 10 and workflows are used in conjunction with back-end integrated services with complete channel management through a managed network to deliver enhanced online business transaction services and communications through an international network.

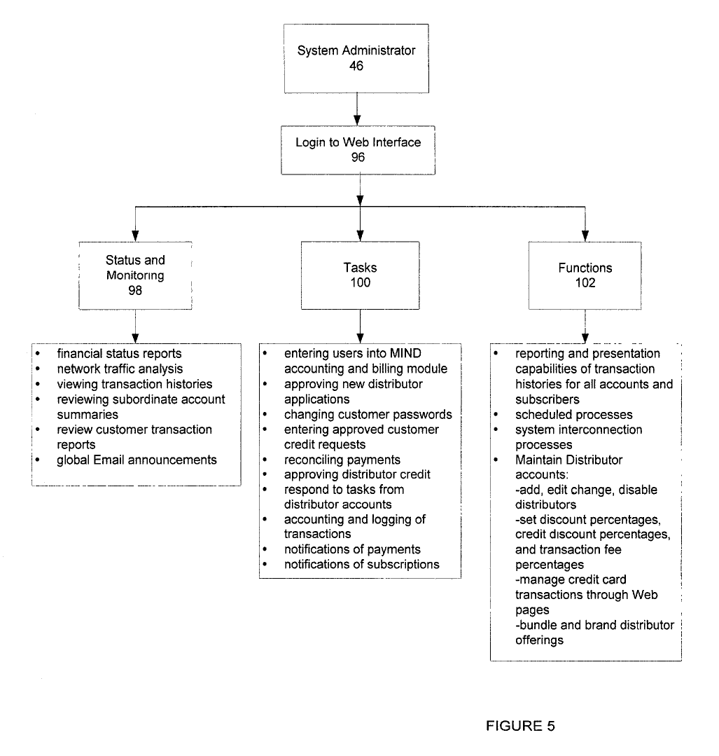

Referral is now made to FIG. 5, illustrating the workflows and operations of the system administrator, which is the top level account in the subscriber hierarchy of the system. The system administrator 46 accesses the platform through the Web interface that displays selections for status and monitoring, tasks, and functions operations. For the system administrator, status and monitoring operations include network traffic analysis, financial status reports, viewing transaction histories, reviewing child account summaries, customer transactions reports, and a global Email announcement selection. Task selections for the system administrator include, approving new distributor applications, changing customer passwords, entering approved customer credit requests, reconciling payments, and approving distributor credit.

A task 100 may be generated by the system administrator 46 when new users have been entered into the system by distributors 48 or resellers 50. The system administrator 46 inputs the new user into the billing database so that call usage can be tracked. The system administrator 46 may also respond to a task that is a request from the distributor either during the subscription process or from an existing approved distributor account. Tasks 100 include entering users into an accounting and billing program, such as MIND, approving new distributor applications, changing customer passwords, entering approved customer credit requests, reconciling payments, approving distributor credit, responding to tasks from distributor accounts, accounting and logging of transactions, notifications of payments, and notifications of subscriptions. Functions 102 of the system administrator include reporting and presentations for all accounts, scheduling processes, system interconnection processes, and maintaining distributor accounts. The system administrator manages distributor accounts by adding, editing, and disabling disributors; setting discount percentages, credit discount percentages, and transaction fee percentages for distributors; managing credit card transactions through Web pages of the platform; and bundle and brand distributor offerings of goods and services.

Status and monitoring capabilities 98 of the system administrator 46 include generating finacial status reports, network traffic analyses, viewing transaction histories, reviewing subhordinate account summaries, customer transaction reports, and global account announcements.

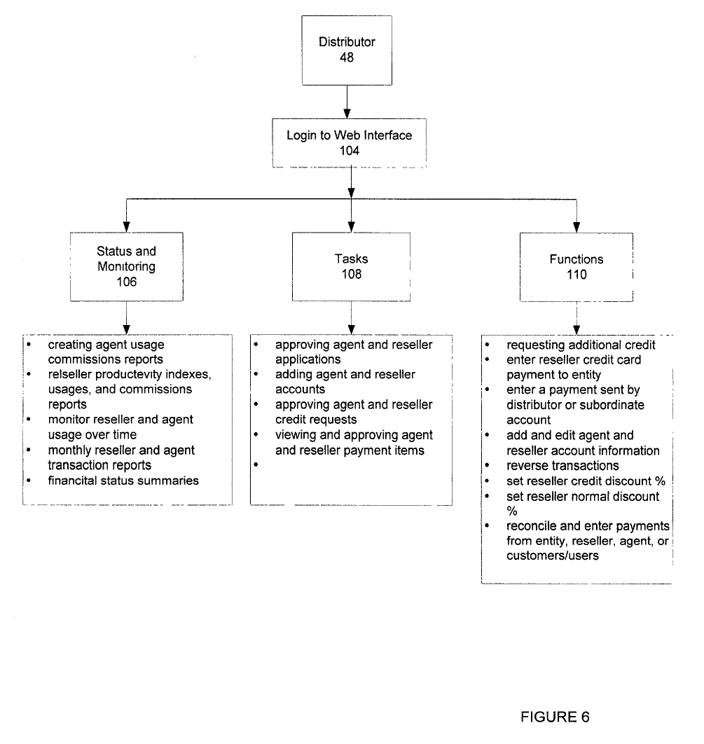

FIG. 6 illustrates the status 106, tasks 108, and function operations 110 of a distributor 48 within the system. After logging into the system through an Web interface, a distributor 48 can access the operations of the platform to which it has been granted privileges by the system administrator. Status and monitoring operations 106 of a distributor include creating agent usage commissions reports; reseller productivity indexes, usages, and commissions reports; and monitoring of reseller and agents usage and performance over time. Additional transactional and accounting monitoring by distributors includes financial status summaries, monthly reseller and agent transaction reports, and financial status and reports of subordinate accounts. Tasks 108 of a distributor 48 comprise approving reseller applications and adding unlimited reseller accounts, including having the itself distributor operate as a reseller. Distributors may add and edit accounts through simple procedures directly through the distributors' home Web pages on the platform. Additional tasks for distributors include approving reseller credit requests, and viewing and approving reseller payment items. Functions 110 of the distributor include requesting additional credit, making a credit card payment to the administrator, entering a credit card payment to the administrator, enter a payment sent, add and edit information for resellers and agents, reverse transactions, set reseller normal discount percentage, a set reseller credit discount percentage. Through an online reporting system, distributors may analyze customer or reseller credit requests, reconcile and enter payments from the system administrator, resellers, or customers.

Distributors may add their own agent accounts without having a reseller. Distributors and their agents operate within a defined set of parameters from the system administrator. Tasks generated within the transactions are transferred either to the agent or the distributor for each area as defined in the business model. Functions will also be transferred according to the characteristics of the model. Products and services are attached to the agent as defined. One agent may hold different sets of information for different products or services. For example, multi-currency transactions within the system is available where agents are related to specific methods of collecting with particular flows attached to each method of collecting. The flows between the end user and the distributor are defined according to the type of relationship dictated by the business model selected and the parameters chosen by the distributor at the time of agent creation. All changes made to any profiles will affect the transactions from the change of the process forward, on a real time basis. The transactions up to the moment of the update are posted through the accounting applications at the rate of the current values.

The distributor has the ability to create subscriptions and access to the system. The distributor in e-commerce is a live business connection supported by personnel conducting business with it own customers directly or indirectly. The distributor has the ability to create intermediary objects between itself and its users or customers according to the type of business transactions completed, allowing the distributor to differentiate the type of conditions given between different objects, to groups of users in different categories, and for business classification reasons.

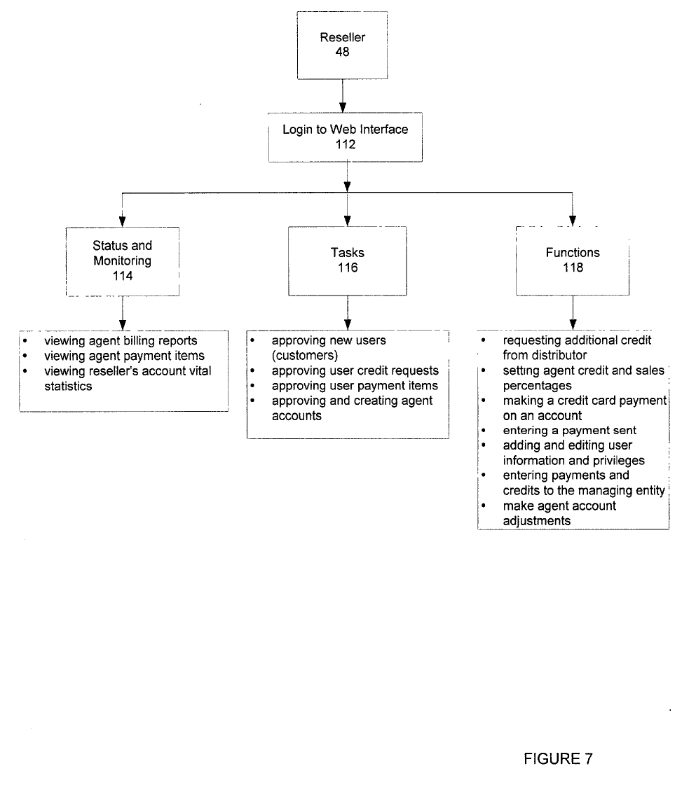

Referral is made to FIG. 7, which illustrates the status 114, task 116, and function 118 operations of a reseller within the platform. Status and monitoring operations by resellers include viewing agent billing reports, payment items, and account vital statistics. Tasks 116 by resellers include approving new users, approving user credit requests, and approving user payment items. Functions 118 by resellers include requesting additional credit, making a credit card payment on an account, entering a payment sent, adding and editing user information and privileges, and entering payments to the system administrator. Resellers may approve and add new users, approve user credit requests, manage and approve user payment items, view account status and statistics, request additional credit, make and enter payments, and enter customer payments and credits to the system administrator.

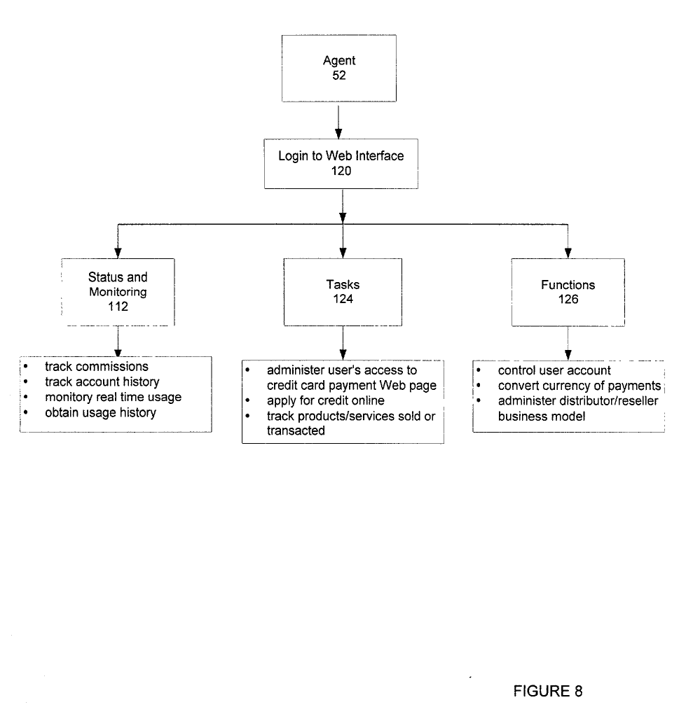

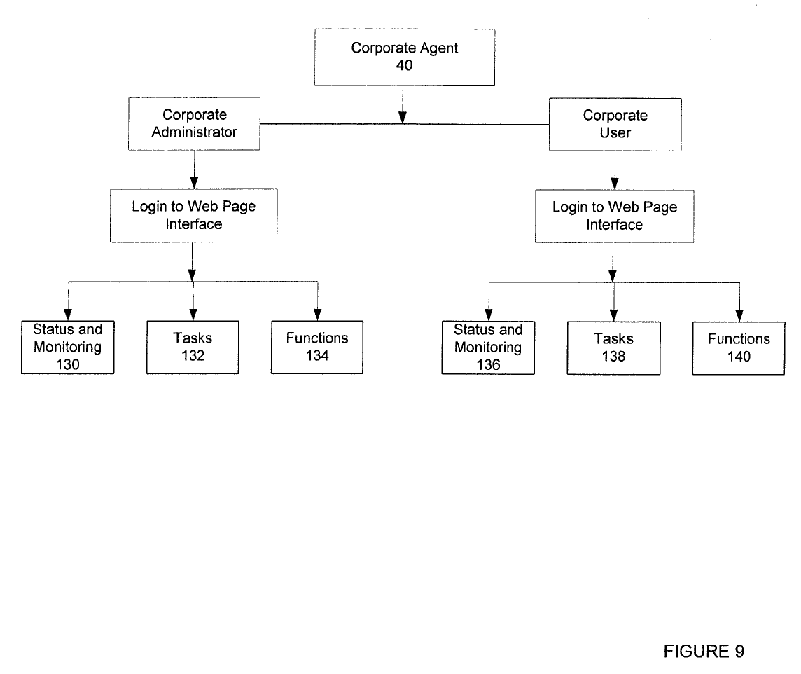

FIG. 8 illustrates the operations of agent 52 module of the platform. The agent provision is a tool for distributors 48 to manage one or more users 54 according to business relationships and status between the distributors 48 and users 54. Agents 52 may be defined to serve a number of users 54 or may be a group of calling cards. The system for agent creation is customizable depending on the type of business the distributor conducts. Every distributor 48 has the ability to create agents 52 based on the products and services to be delivered, as well as the business relationship they want to establish between them and the end user 54. Distributors create agents through the use of a user-friendly “web wizard” that guides the distributor through teh process of creation. The wizard allow s the distributer to set the characteristics, functionality, language, and any other parameter defined in the type of business model the distributor wants to create.

All tasks generated through the agent creation process are transferred between the agent, distributor, and system administrator according to the type of business model. Products and services will be attached to the created agent. One agent can associate with different sets of data for different products or services. Multi-currency setups for agents are optional. Agents can be related to specific methods of collecting particular monetary flows such as credit cards, cash, or check. associated with different methods of collecting. Flows between the agent, and distributor will be established initially according to the business model chosen during agent creation.

Status and monitoring operations by an agent 52 are tracking commissions, tracking account history, monitoring real time usage, and obtaining usage history of its own account. Tasks performed by an agent include admisnister a user's access to credit card payment through a Web page, applying for credit online, and tracking products and services sold or transacted. The agent 52 can track its own commissions and account history, control user accounts and monitor real time usage, obtain usage history including customizable call detail records (CDRs), and access reports, apply for credit online, and access and administer user's access to the system's Web-based credit card payment terminals at any time using the system interface through the Internet.

Classes of agents 52 can be created, but multiple instances of classes are available to the distributor 48 as well for spreading the subclasses (or end users 54) into different agent objects to satisfy any need for aggregation. The agent objects may or may not be administered manually. The objects can be re-directed to superclass objects for management, such as a distributor object to which the agent and user object belong. Notifications, tasks, and administrative functions reside either in a manned agent, or redirected in an unmanned agent. If the agent is unmanned, then the interface will be operated through an agent's parent account.

The agent provision also allows the system administrator to serve many different classes of distributors, which have similar intrinsic functions as distributors, but that through the use of different types of agents as classes, create different types of object users. In this way, distributors may create a completely different distributor model and user connection behavior. An example is the creation of a corporate customer master account, as a corporate object, as opposed to the creation of an individual user object account. The system agent class type defines an object. One type of class of user objects created by the agent is a consumer. The consumer may be an individual end user, small business, or other individual accounts. These are permanent individual accounts with access to the system and its functions as defined by the agent. Examples of system functions available to consumers include reviewing invoices and purchasing more time on calling cards. A batch of calling cards themselves may represent a class. The interface of the system's billing software can be used to manage the batches of cards, including reporting and producing statistics on the class batch. A corporate class may be created that contains a template within the billing package.

The corporate agent module 40 is a specialized type of agent 52 includes corporate user and corporate administration provisions 58. The corporate interface can be branded to appear as the distributor's or agent's own service pages. A corporate subscriber obtains a master account and a default tree into an accounting system 92 for corporate administration. The master corporate account is linked to the system's E-commerce interface 38 as the bridge between a distributor 48 and the distributor's corporate user 60.

The corporate agent 40 performs management and reporting of its corporate sales and transactional activities. The agent can manage accounts defined by personnel, projects, or places to create, edit, balance, track, and report activities. The corporation can sponsor employees into the system through self service and a GUI interface. The corporation can track employee and serve the needs of employees, customers, and partners through consolidated operations and individual sub-account controls configurable by the corporate administrator.

Corporate communications are controlled by the corporate administrator 102. The corporate agent accesses the system's communications provisions as well as controls its own communications tools. The corporate administrator manages the setup of unified messaging and telephony services. Revenue can also be generated based on the revenues for users of an e-room.

The corporate user 60 interacts with the available menus and provisions of the system through standard or branded Web pages. The corporate user's Web interface pages 142 can be customized, or branded, similar to other modules within the system. The corporate receives privileges from corporate administration 58. Functions 140 for the corporate user include all the functions of the standard agent 52 module in addition to entering personnel and projects into the system, managing indivudial configurations of account lines, and providing access to communications. Tasks 138, in addition to standard tasks of the agent 53 module, include creating sub-account controls, managing sale and ordering of inventory. Status and monitoring 136 of corporate users include tracking customers, partners, daily reporting to master accounts, creatings, editing, balancing, and tracking account activities. The corporate user 60 has access to details of sponsored account and personal account balances. The user may manage its own unified messaging box. The user has control over master communcations configurations for product lines, extensions, and accounts inventory. The user can create its own follow-me extension within the communications module, for redirecting calls and Emails to office, home, cellular devices, PDA's, and pagers. An additional function allows the user has access to accounting software for its accounts to add text tags to add to its own balances for parent account review processes, such as descriptions of expenses or notes to management.

The corporate user Web interface is customizable to show services available for the user, links to outside services, and links to corporate databases. This gives the corporate user flexibility to customize its platform to operate similar to intra company Web pages which creates a quicker learning curve for company personnel.

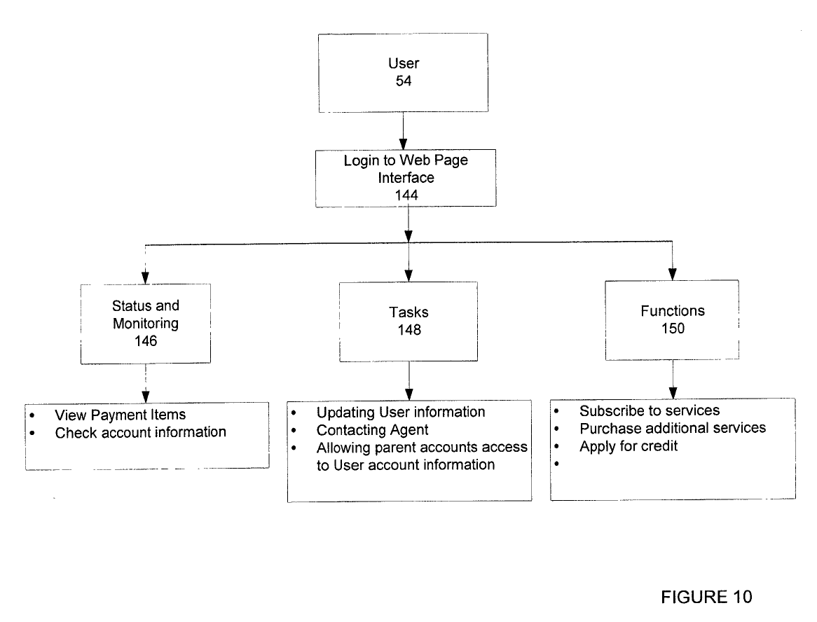

Referral is made to FIG. 10, describing general Users 54 to the system. Users 54 are the retail customers accessing the system through a Web interface 144 and are managed through agents. Status and monitoring operations 146 users can perform include viewing payment items, and checking account information through the accounting server. Operational tasks 148 that the user can generate in the platform toassign to the system administrator include updating user information and contacting the user's agent through the system, approving a distributor for access to the user's subscription and accounting database and contacting its agent via Email. Functions 150 of the user include subscribing to a service, purchasing minutes of long distance, applying for credit increases, and updating user information.

Referring again to FIGS. 1 and 2, the IP Manager 42 is the network administrator for all hardware and software associated with the entire system including servers 16,18 that house the files and databases 20,21 used to run the platform, and also for the global network and configuration that includes each individual gateway 14 configuration. The IP manager 42 has duties such as network traffic analysis, hardware and software installation and upgrades, installation and monitoring of remote voice over IP gateways and network lines, and assistance to subscribers with operation of the platform software. The IP manager merges the E-commerce applications for all transacting parties with automated functionality and provides for virtual network management of IP communication provisions.

The IP manager manages the network inventory throughout the system, thereby creating a consistent and interoperable network for all users. As new gateways are added, the IP manager registers each gateway and the activation process to add the gateway with portal and gatekeeper functions for service activation. The IP manager is responsible for real-time management of network access through partner companies, hardware devices such as gateways, routers, and switches, trunklines and individual trunks to gateways, ports and individual ports within gateways, and extensions such as DID lines into individual lines into ports. The manager is the nerve center between network operations, administration, service creation, and partners.

The following exemplifies operations of the preferred embodiment of the present invention. A user may request a credit increase. The platform will search the agent profile database and look at records associated with the agent and learn that the information and tasks created by the user function at the particular time of request is to be presented to the agent at that specific moment while the transaction is occurring in the agent's task and information Web page. Another agent, created by the same distributor, might have the same tasks and information from the credit request presented in the Distributor's end user task and information page, bypassing the agent as an information and task intermediary. This scenario could occur if the agent is configured to being only an internal sales person with non-administrative capabilities. Both agents can co-exist in the system with the same program running both scenarios, but branching dynamically according the records stored in the profile database.

A second example is a user is conducting an electronic payment with a visa card through the system. The system will search the agent profile affiliated with the user to determine if the agent is charged a transaction fee based upon the percent of the exchange. This parameter is set by the agent's distributor when the agent was created through the web wizard. If the agent is charged a fee, then the agent is debited the amount. If the agent is not charged a fee, then the charge can be shared between the system administrator and the distributor.

### Communications

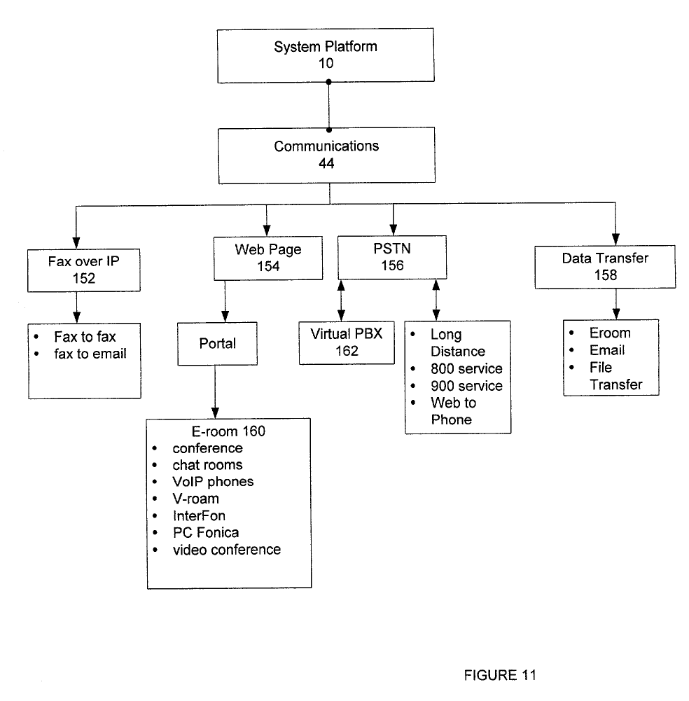

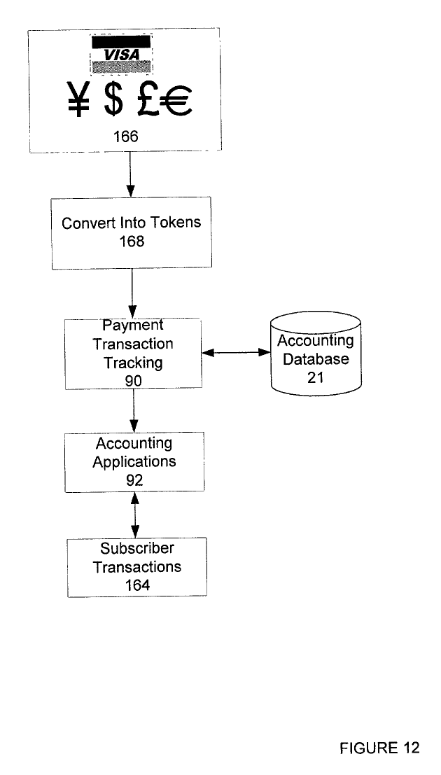

The Internet communications applications integrated into the system platform take advantage of the benefits derived from having state-of-the-art managed network, gateways, and routers combined with wide bandwidth available to each subscriber. Referring to FIG. 11, the platform 10 links subscribers with communications application 44 using Internet telephony 154, facsimile 152, and data transfer 158. Voice applications accessed through subscriber Web pages is integrated with customized and off-the-shelf communication applications utilizing the managed network infrastructure.

E-room 160 is an access Web page for free and fee-based communications services. The e-room communications center is a browser-based solution for an additional access point to the platform system, including billing information for accounts with such capabilities. The E-room page may be customized and branded for each individual distributor, employee, end user, customer, etc. The Web page template can be modified to display service and account access appropriate to the user's account privileges.

Communications between subscribers centers around the e-room. The e-room module is accessed through the Internet at the Internet Web site E-room.net and is a communications tool integrated into the system platform for access by subscribers to chat room by Hear Me, Webcard by Mediagate, and Webphone. The platform is a single point of entry to harness existing services on the Internet, integrating these as communications tools into a billing, accounting and transactions platform. The enhanced services portal of the E-room allows transactional revenue to derive from the sale of prepaid calling cards, software applications and communications peripherals such as headsets, sound cards, and single-port PC gateway boards. E-room functions as a business oriented, commerce, and communications enabled corporate portal. E-room is the communications home for the system administrator, distributors, and their agents, the corporate customers and their employees, with each individual person receiving a different personal page based on their roles, wit access to the data only they have access privileges to review. E-room services are presented in user-friendly formats for usable directories, messaging through a single port of entry for the communications services, administrative capabilities, customer support, and corporate module entry.

Voice agent is a module within the platform created by a voice over IP service reseller. The communications network and voice over IP gateways are maintained by the IP Manager, thereby freeing the system subscriber to concentrate on expanding its business and removing subscriber's overhead of managing a network. The system administrator can direct communications over managed digital networks, the public Internet, and the PSTN. The communications provisions gives subscribers access through a computer, land-line telephone, wireless telephone, or PDA, depending upon the service and provisions subscribed thereto.

The communications platform provides voice communications over the Internet. A customer can dial through the platform's Web page interface 154 or directly with a virtual PBX 162 through the managed IP network. Through the platform's real-time account management, a subscriber can use the Web to access information on customer accounts such as detailed calling records, billing statements, account history, and payment information. Because the platform operates through the Internet, a subscriber may establish accounts from any location having Internet access. The communications services of the system platform are integrated into the subscriber's Web page and take advantage of the managed networks and gateways linking hardware and software to subscribers, together Internet's ability to transmit voice, fax, and video while bypassing traditional toll charges on the PSTN. The system PC-to-phone service that allows communication from a desktop computer of voice and video transmission over IP. PC Fonica™ integrates Web applications, such as WebPhone™ into the system platform for use by subscribers and customers.

Traditional telephone services are also integrated into the platform and available for use by subscribers. Web-to-phone services is an 800 and 900 web number. The service is of value in international areas whnere 1-800 and 1-900 numbers are sparse or non-existent. For example, a customer browsing the Web and needing to speak to a customer service or sales representative has no way of reaching a business call center toll free. The platform allows a subscriber to offer 800 service through the public service telephone network (PSTN) or through the maganed private network of the present invention for the subscriber's customers, all as a part of the subscribers setup with the Internet platform. The 1-800 service is a dial-in to a local gateway 14 on the managed network, which routes the call to the appropriate terminated gateway 14 and to the appropriate subscriber. The call by a customer is paid for by the subscriber. With 1-900-Web service, a customer is charged for the call, however the call is handled similar to the 1-800 service through the gateway servers, thereby reducing costs over tradtional calling plans. For example, customers and resellers can communicate with a distributor through the Internet with ClickFon™. ClickFon™ allows a subscriber to establish direct voice connection between the Internet user accessing the subscriber's Web page, and the subscriber. The customer clicks onto an Internet banner on the distributor's web site and a voice call is processed to the distributor's office directly from the Web page.

The present invention provides infrastructure and information access for invoicing, commissioning, subscribing, administration, and E-commerce for subscribers to manage business through the connectivity and cost-effectivness of the Internet. Quality of service is available through a managed IP network. The internet communications and E-commerce system is integrated with a managed network to provide voice, facsimile, and enhanced services over IP and allows for resale of logistics management of these services. Trunk-to-Phone service allows wholesale carriers to terminate international long distance traffic at a fraction of the cost of service provided by traditional long distance companies. The advanced managed network of the present invetnion provides highly reliable, cost-effective business-grade telecommunications services and worldwide termination. Phone-to-Phone allows any type of customer to place a telephone call over the system's managed network by dialing into a public access and entereing preauthorized account numbers and password codes. The system platform will integrate existing technologies and bring them in user-friendly environments through Web pages. Communications options for users include defining user profiles with their preferred method of communication and definitions of virtual extensions. Other options include online voice mail with replies through PC-to-phone calls, fax to email, and wireless pager notification, all available online.

The system integrates group conferencing services over IP. Communication modules to the platform service allow users to interact as a group by simply pointing their browsers to a predetermined web page that they will have as their “voice room.” The voice room can be used for conferencing, customer support, training support, and intercom between teams using voice over IP technology through the managed network. Multiple voice rooms can be utilized as users desire. A user may also join a voice room from the PSTN by dialing one of the managed public access gateways, entering a security code, and then participating in the conference.

A user may also access a virtual PBX directly from a standard telephone. The user can dial direct access codes, have the call processed through the system's managed network and voice over IP gateways and access any other subscriber directly or any number on the PSTN through a terminating voice over IP gateway. V-roaming service is provided for subscribers that travel frequently and need access to their communications accounts when the subscriber is in a different city. V-roaming gives users access to the managed network through gateways located in strategic areas. The user can access the platform network while traveling within areas served by a gateway.

The platform additionally provides the user reliable fax over IP service 152 through the managed network. Any user, regardless of whether they have Internet access, cna use the Internet for long distance facsimile calls. Instead of accessing a long distance carrier network, IP users are routes across the managed IP telephony network and then directed to the closest terminating gateway. from there, faxes are routed over the PSTN to the called number.

### E-commerce

The e-commerce module 38 is a scaled, hierarchical platform. The accounting system incorporated into the platform tracks 12 of electronic funds transfer, credit card payments, or cash between subscribers using rules of engagement between the subscribers. The e-commerce operations provides value to subscribers with the seamless transformation of funds transferring between user objects and agent or distributor objects. The process of entering money into a user balance also implies a transaction between other objects, such as an agent and distributor. Monetary transactions in the system are based on transaction types, categorized according to the different states of the objects at the moment of the transaction between the objects, including balances and types of commercial parameters such as discounts and credits. The platform provides the ability to manually receive funds and cause automatic transactions to occur. System transactions, such as billing, are affected as if an electronic transaction had occurred. The act of receiving money, collecting money, or paying, is also modified into its electronic format based on the business model being used and the state of the values at the time of the transaction. The e-commerce module provides an electronic fund conversion system between real dollars and electronic tokens at the conversion rate that was defined between subscribers. The module also provides notification, messaging, and transaction generating capabilities as part of the Web interface for the platform.

The system platform is flexible to integrate with external vendor software such as billing packages for voice services and for enhanced online business services and sales 92. These types of integrated software applications provide Web-based interactions and APIs for system interaction as the result of transaction logic. The vendor packages are primarily integrated for custom user object creation, and transactional information for the user is kept on the packaged software. The system provides the door to sophisticated vendor packages by extracting the most important functions from the packages for use in the system that the classes of users will perform. The system platform provides the necessary interaction between programs for the workflows, classes, messaging elements, and other components to perform necessary actions within the vendor systems to complete the transactions made by the user objects. In an exemplary embodiment, Mind™ and Portal™ billing software packages are integrated into the system platform. These are commercial accounting software packages to keep track of accounts received, accounts payable, and accrued charges, such as time billed for voice over IP communications applications, at any level of subscriber for products and services.

The e-commerce accounting 42 and payment system 90 is governed by rules of engagement. The administrative rules for payments and transactions are as follows: the end user pays an agent, customer, reseller, one of which then pays the distributor, and the distributor pays the system administrator. If the parent account to a subscriber is an administrative relationship, then the subscriber can use workflow progress to control flows. A parent subscriber can assume the identity of its subordinate subscribers for credit, debit, and account management purposes. If the parent account is not an administrator, the parent subscriber can only receive payments through credit cards within the system and the parent can inform the system administrator that a payment has been cleared from the subordinate subscriber. If the parent account has a balance, it can allow a debit to the balance to give the subordinate account a credit upon the system administrator being informed of the payment clearing.

The preferred embodiment is designed to provide an infrastructure for an entity selling a product or service through the Internet. The system automatically provides commercial relationships with volume discounts, maintenance of monetary balances, discounts for buyers, and recording transactions in to accounting databases. Each account can customize the transactional rule for its particular buyers or sellers, giving a discount or a credit selectively. If a supplier given credit by the system administrator does not have enough cash in its account to complete a sale to a buyer, the transaction is completed by the system administrator on credit.

The transactions are performed in tokens credited to a subscriber's account. When a subscriber adds funds, in any currency, to an account balance, the funds are converted into a common currency called tokens that are based on a percentage of U.S. dollars. This creates consistency and accuracy with exchange rates. The account balances are handled by each account's distributor. The platform accounting system tracks and exchanges the money between businesses, customers, and lateral accounts. The system administrator may receive funds electronically in the name of a distributor or agent and then check on the status of account balances of the parties to determine if the buyer has enough tokens to buy products from another subscriber in order to satisfy the order of the customer. The customer can pay by credit card to the administrator, which credits the agent or distributor with the payment. If the agent or distributor does not have enough tokens to fulfill the order, the administrator fulfills the account and order and creates an account payable towards the distributor or agent.

Transactions can be performed and tracked within the system for credit cards, and electronic banking. Transactions can also be performed outside of the electronic system but tracked within the system. This is a scenario where a check is sent to a distributor's bank and the check clears as a deposit into the account. A transaction can also occur completely outside of the on-line system and be tracked manually with the accounting system. The transactional information is entered into the system by both the initiator and receiver in the transaction. The system acts upon transactions performed and tracked within the system, pre-payments that are collected and tracked inside the system. The system can also be modified to act upon information entered by an authorized party of a transaction being clearing in the process and have the system track the collection of the payment although the collection is external to the system. the system may act upon information provided by a user on the result of the process of collection, tracking, and clearing of payment. The information must be presented in view of the originating party as well as from the receiving party. Every task has to appear on all of the parties' accounts involved. The subscriber who initiated the task enters the information as a task initiated, and the subscriber who received the task enters the information as a task received. The party that is supervising or participating in the task receives the information as a task in process.

The System Administrator can vary transaction fees as a percentage of the overall transaction. Transactions for which fees can be charged include use of the credit card terminal, accounting of tokens, or monthly rates on a sliding scale. Profits generated from transaction fees can be returned to the appropriate distributor or distributor's subordinate accounts, or kept in the subscriber's account as a credit towards future purchases.

A corporation creates revenue by implementing advanced payable services based on the numer of active user accounts and E-commerce applications available for integration under the system platform. The system creates a log for every corporate business and billable transaction. Corporations work within the E-commerce pay tracking module utilizing electronic tokens for purchasing products and services. Accounting reports can be created of transactions between the system administrator and a distributor, a distributor and an agent, a distributor and the end user, and between an agent and an end user. The distributor can customize the types of transactional data for the system administrator to track when the agent is created. Detailed accounting data from business transactions are saved on the system administrator's billing and customer database servers. The system creates a master accounting of all levels and legs of the commercial relationships within the system from system administrator at the top to each customer and agent leg.

Therefore, because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

I claim:

1. A scalable system for electronic commerce and communications over a network, comprising:
an electronic commerce module for processing and accounting commercial transactions between a plurality of subscribers and end users;
an application platform for processing and accounting commercial transactions between said administrator and said plurality of subscribers;
a telecommunications module comprising infrastructure providing a plurality of digital communication applications used by said subscribers through said network;
a system manager module for management of said application platform and said telecommunications infrastructure.

2. A scalable system for electronic commerce and communications over a network, comprising:
an electronic commerce module for processing and accounting commercial transactions between a plurality of subscribers and end users;
said commerce module comprising an administrator and a plurality of said subscribers to said platform arranged in vertical commercial relationships;
operational capabilities provisioned to each said subscriber according to rules governed by said administrator;
an application platform for processing and accounting commercial transactions between said administrator and said plurality of subscribers;
a telecommunications module comprising infrastructure providing a plurality of digital communication applications used by said subscribers through said network;
a system manager module for management of said application platform and said telecommunications infrastructure.

3. The system of claim 2, wherein:
said vertical commercial of relationships of said subscribers include a system administrator, at least one distributor, at least one reseller, and at least one agent linked by a vertical chain of operational rules and workflows.

4. The system of claim 2, wherein:
said electronic commerce module incorporates an accounting system to track payment transfers between a plurality of subscribers based upon the business model used and the state of the values at the time of transaction; and
said business model is governed by rules of engagements based on said vertical commercial relationships of said subscribers; and
a parent subscriber account can assume the identiy of its subhoridate accounts for credit, depti, and account management purposes.

5. The system of claim 2, wherein:
each subscriber account can alter transactional rule for buyers and sellers, thereby giving discounts and credits selectively to complete a sale or purchase.

6. The system of claim 2, wherein:
said electronic commerce is performed in tokens that represent monetary balance and credit in a subscriber's account converted into a standard currency rate for the entire system.

7. The system of claim 2, further comprising:
a corporate agent module for managing and reporting sales and transactional activities of a corporate entity within the system;
said agent module comprises a corporate user and a corporate administrator;
said corporate administrator controls said communications module operations within said corporate entity; and
said corporate administrator manages subhordinate accounts designated for employees, partners, and customers;
said corporate user receives privileges from said corporate administrator to operate within said system by completing functions, tasks, status and monitoring reviews.

8. A scalable system for electronic commerce and communications over a network, comprising:
an electronic commerce module providing a platform for a first subscriber to conduct commercial transactions over the Internet with a second subscriber;
said electronic commerce module having vertically arranged relationships of said subscribers of system administrator, distributor, reseller, agent, and users;
a corporate agent module to provide corporate user management and tracking of sales and transactional activities and corporate communication managment;
said subscribers and said users conducting said electronic commerce according to workflows defining rules of engagement and accounting;
a network manager module managing network architecture, operating systems, and application software throughout the system;
a communications platform to provide digital communications between said subscribers and said users, said communications platform utilizing said network architecture to transmit said digital communications through the Internet between gateways integrated to said network.

9. The system of claim 8, wherein:
said electronic commerce simulatneoiusly serves a plurality of subscribers in said vertical relationship that are parties to the same transaction.

10. The system of claim 8, wherein:
said subscribes are organized according to different classes based on the status of said subscriber in relation to said workflows.

11. The system of claim 8, wherein:
said subscribers include a system administrator, a distributor, a reseller, and an agent.

12. The system of claim 8, wherein:
said workflows include status and monitoring operations, functions, and tasks that are accessed through Web pages to the system;
said status and monitoring operations include reporting and reviewing transactional histories of commercial transactions;
said functions are processes initiated by the subscriber, and
said tasks are generated by a first subscriber interaction within the system that causes a second subscriber to act upon the task.

13. A network for electronic commerce and communications over the Internet, comprising:
at least one server containing an application platform that comprises communications and accounting applications;
a plurality of gateways serving connecting subscribers and users to said platform through the Internet to an electronic commerce module for processing and accounting commercial transactions between a plurality of subscribers and end users;
said commerce module comprising an administrator and a plurality of said subscribers to said platform arranged in vertical commercial relationships;
operational capabilities provisioned to each said subscriber according to rules governed by said administrator;
an application platform for processing and accounting commercial transactions between said administrator and said plurality of subscribers;
a telecommunications module comprising infrastructure providing a plurality of digital communication applications used by said subscribers through said network;
said communication applications include voice, facsimile, and data transmissions.
